(19) United States
(12) Patent Application Publication
(10) Pub. No.: US 2010/0318373 A1
(43) Pub. Date: Dec. 16, 2010

(54) Carbon footprint determination device

(75) Inventor: Scott C. Harris, Rancho Santa Fe, CA (US)

Correspondence Address: SCOTT C HARRIS;Law Office of Scott C Harris, Inc, P O BOX 1389, Rancho Santa Fe, CA, 92067-1389, US

(73) Assignee: HARRIS TECHNOLOGY, LLC, Rancho Santa Fe, CA (US)

(21) Appl. No.: 12/484,175

(22) Filed: Jun. 12, 2009

(51) Int. Cl. G06Q 10/00

(52) U.S. Cl. 705/1.1

(57) ABSTRACT

A carbon footprint calculator that carries out certain parts of the detection of the carbon footprint automatically.

### BACKGROUND

The promise of global warming has alarmed many people. Many have tried to minimize their effect on global warming on the environment. People want to monitor, and perhaps minimize their “carbon footprint”—the amount of energy they consume that releases carbon dioxide, e.g., caused by burning of fossil fuels or other actions that removed trapped carbon into the atmosphere.

It has been suggested that people could take certain actions to offset their carbon footprint. Plants can consume carbon dioxide and hence offset some of the carbon released by everyday activities. Some have suggested buying credits towards carbon reducing actions, such as renting areas where trees are being grown. These credits might be used to offset other actions that did release carbon dioxide, to reduce one's carbon footprint.

### SUMMARY

The inventor recognized that many people might be interested in keeping track of their carbon footprint. In addition, by monitoring one's activities that create carbon emissions, it may be possible to take actions that reduce those emissions, e.g., by doing things in alternative ways.

### BRIEF DESCRIPTION OF THE DRAWINGS

In the Drawings:

FIG. 1 shows a portable computer and its operation;

Based on recognizing this need in the prior art, the embodiments describe a carbon footprint calculator. One important aspect, however, is that as much of the determination as possible should be automatically done. For example, the users will not want to manually enter all of their activities each day, and would prefer to avoid doing that.

An embodiment describes a carbon footprint calculator that automatically tracks certain actions, and automatically uses this tracking of actions to monitor a person's overall contribution to carbon emissions. One aspect also suggests actions that can minimize the amount of carbon emissions by suggesting alternative ways to reduce the carbon emissions.

An embodiment recognizes that portable devices which come with such phones are inherently capable of carrying out certain calculations. These devices also can store calendar programs with a person's schedule. As the person moves from place to place, they often take these devices with them—e.g., they take their phone or PDA as they travel. The computer within the device can use the information it obtains to deduce what a person is or has done.

The device can also store lists that allow the program to determine actions that they take that increase their carbon emissions, and also possibly take action which may result in decreasing their overall carbon emissions.

According to an embodiment, this application may be carried out on a portable computer such as a PDA or laptop which has GPS or other position determining capabilities built therein. Most PDAs with cell phone capability also include the so called E-911 capability.

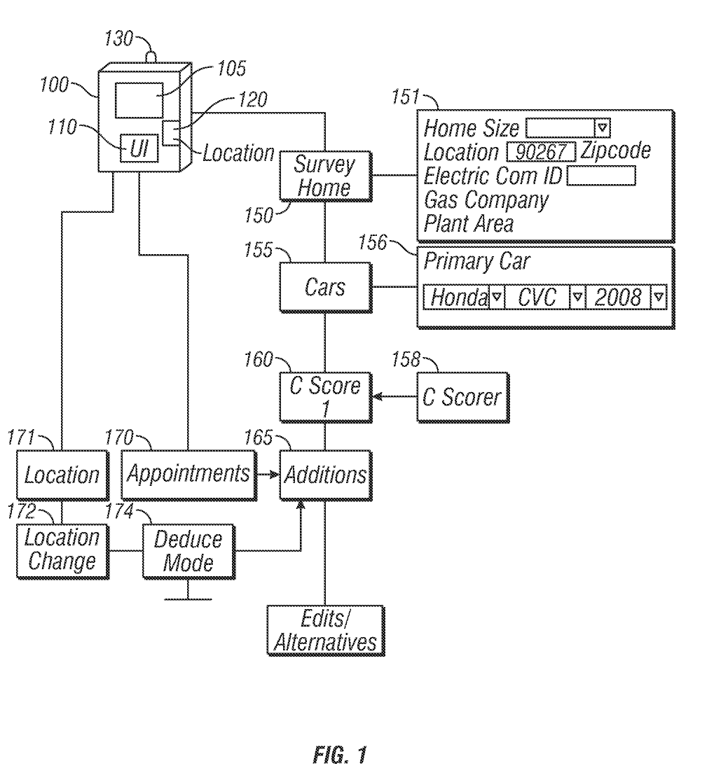

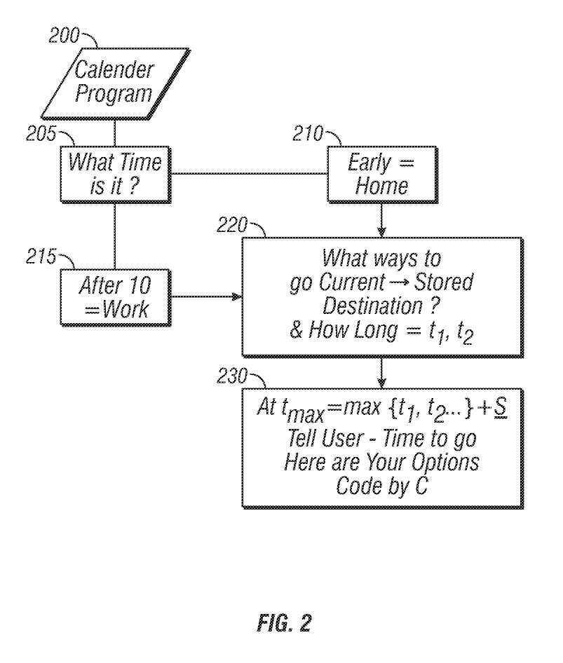

The operation of the device may be as shown in FIG. 1. FIG. 1 shows the PDA 100 with display screen 105 and data entry part 110 e.g. a user interface. The PDA may also include a location sensing device 120 for example a GPS device or a triangulating device which automatically detects location by sensing known landmarks.

In an embodiment, initially a baseline survey may be carried out at 150. 151 shows the user interface which may be used for that survey. As much of this as possible may be automated. A user's home size may first need to be determined. The user may know (via previous registration) or otherwise obtain the user's home address. Using services such as google maps or otherwise the size of the rooms may be determined. Alternatively, the user may manually set their home size. The zip code can be used to obtain an estimate of utilities used per square foot by a home such as this. The maps, e.g., Google Map's satellite imagery, can be automatically analyzed to determine how much of the land is devoted to plants, and the kinds of plants that are on that land. An estimate of the carbon absorbance by those kinds of plants for the zip code can be made, and used to determine an approximate value.

In one embodiment, the system also includes a link to a utility ID, for example an account number for the utilities, or other code given by the utilites to allow monitoring of the actual power consumption amounts. An electric company ID may return, for example, information about the use of electricity. Similar operations may be carried out with the gas company.

In a similar way, the cars can be surveyed at 155, using routine 156. Information on the vehicle(s) can be manually entered, or a vehicle's VIN number can be entered, and information about the vehicle automatically input.

In one embodiment, barcodes on the vehicle can be used by obtaining a photo of the barcode using the camera in the PDA, and either directly decoding it or by sending it to a remote location for decoding, e.g., to a database site.

The routines such as 156 may run on the phone, or may be an applet which is initiated from a remote location to provide a user interface to the phone. Since these actions only need to be carried out when things change, this may be done on an internet site, and the values transferred to the portable program.

The system may also, for example, ask for a number of plants.

As an alternative, a carbon score system 158 may be used to calculate a carbon score, where the carbon score is calculated by a service where an external service analyzes the home.

According to another embodiment, for example, the carbon scoring system may manually review a satellite image, e.g., the google maps for example, image of the user's house, and allow the user to draw areas on that underlay. The user can drawn an outline and select “House”, “yard”, etc. This can be used to score the amount of carbon that is being released.

The carbon used by a user's office can be similarly determined, e.g., by setting the building, information about the building, number of people in the building, etc.

The final carbon score at 160 as determined by the above or by any other technique, sets a daily or weekly carbon score: setting a user's baseline carbon use.

Additions to the carbon score are calculated at 165. One such addition may be obtained by finding the appointments on the user's calendar within the PDA 100. For example, a meeting which is set to occur at 2 PM may require transportation to that meeting.

This system may determine, for example, an average carbon emission per mile of single passenger transport, public transport, etc and select one of them. It can also determine actual carbon emission for the user's vehicle, along with the number of miles travelled.

This system can be used by itself, or also by detecting location change at 172. A location change at 172 may be analyzed at 174 to deduce the mode of transportation. For example, this may sense a person moving at more than 20 miles an hour, and from that, deduce that the person is moving in a driven vehicle such as a automobile. By correlating the location detected at 171 with the speed, the system can deduce the most likely mode of transportation. For example, in Los Angeles, moving at any speed is most likely to be via automobile. However, in a city such as New York, the movement may be via taxi, bus or automobile. If the system loses communication with the location device for a time, and then re-obtains at some other time, this may be taken as a subway ride, tunnel, airplane, or other. If the start location is near an airport and the end location is near another airport, this may be taken as an airplane trip.

The automatic detection of the mode of transportation can be used for other applications with a portable computer.

The user may be prompted to ask them which way they are actually traveling, if there are multiple options or the system may make a determination. For most situations, it will be apparent from the movement which way they are going. However, the user will be given the ability to update the way they are moving; that is, any deduction will be correctable.

The user can also set characteristics of how the baseline score (score obtained at 160) will be modified by the movement. For example, a user may set characteristics that public transportation has a carbon score which is not counted. This may be done in recognition of the fact that there is no additional marginal carbon added when one additional person uses public transportation such as a bus or subway. Conversely, however, traveling in an automobile may be used along with the characteristics of the automobile to determine an addition to the baseline.

Other activities can also be used as subtractions from the baseline. For example, the user can take certain actions such as purchasing shares in renewable power, or purchasing so-called shares in services that supposedly absorb carbon emissions, in order to subtract from their baseline. One of the features may be a subscription service that allows a user to purchase shares depending on their actual carbon usage for any period, e.g., for a week.

According to another embodiment, the user is provided with alternatives of ways to get from one location to another. One embodiment as in FIG. 2 may use the computer to analyze the entries on the user's calendar program, e.g, on “Outlook™” at 200. The system determines time of day at 205, and based on time of day, the user can be assumed to be at home at 210 or at work at 215. Another embodiment may use the locations found by automatic position location, e.g., by GPS or triangulation, to obtain a location, and use the last good location as a postulated current location.

Based on information stored in the calendar program, the system can deduce that the user needs to get to a certain location by the time of the appointment. Also based on the current location, there may be many ways to get to that appointment location.

These may include driving one's own car, taxi or hired car, public transportation (bus/subway), bicycle/walk (based on the program's storage of some reasonable walking and/or bicycling distances), carpool, or any other means of transport. If the meeting is farther away, e.g., 200 miles, the program may analyze the difference between driving and flying. The detection of time may include a system-stored time before transport. For example, if the user is driving, they might need 10 minutes to get their car, if taxi, they might need 5 minutes to get the taxi. If the system determines that the distance might be far enough to require airplane reservations, then an appropriate time for reservations can be set, e.g., a two week advance. The value S is set as the time to make the decisions.

The system can find the different ways to go based on stored preferences, and based on internet access, e.g, to travel sites such as expedia.com and/or American express travel. All the different options may be compiled at 220. Each way to travel has an associated time t₁, t₂, . . . tₙ.

At 230, the system determines a time tₘₐₓ, the maximum among all the times tₙ. That time represents the maximum time it will take to get to the appointment. That is added to the overhead time S at 320, and at that time, the user is told of options including the different ways to get to their appointment, the different C scores and the different prices for the different options (e.g., best airline price, vs estimated price for driving; price to go by taxi vs price to go by car and park).

This can be done to determine the best way to go for the future action. This can also be used to determine whether a past action may have been the best way to minimize their carbon score.

For example, either the PDA may store information about mass transit options in the program, or a link to an external service or website may include detailed lists of transportation routes, from one point to another.

Although only a few embodiments have been disclosed in detail above, other embodiments are possible and the inventor intends these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, other devices can be controlled in this way. The detection of actual location can be used for other program functions. Also, the embodiments describe the user's calendar being analyzed for carbon emission, but the system can alternatively evaluate any of the information described herein to find a lowest-cost way, or shortest time way, or getting to the locations in the user's calendar, instead of determining the carbon footprint. These alternatives may store a database of costs (e.g., including parking, tolls, cost per mile) and/or a database of times to traverse roadways at certain times of day.

The above embodiment has described operating using a portable computer, such as a PDA. However, the operations described herein can also be carried out in any computer, and more preferably, any mobile computer. In one embodiment, for example, the operation is carried out in an onboard computer on an automobile, that calculates carbon scores for actual trips taken, and uses its GPS and traffic database to calculate probable carbon scores for different routes. One embodiment may use a probabilistic scoring system that take probabilities of different scorings at different times of day, such as that described in U.S. Pat. No. 6,604,047.

Also, the inventor intends that only those claims which use the words “means for” are intended to be interpreted under 35 USC 112, sixth paragraph. Moreover, no limitations from the specification are intended to be read into any claims, unless those limitations are expressly included in the claims.

The computers described herein may be any kind of computer, either general purpose, or some specific purpose computer such as a workstation. The computer may be a special purpose computer such as a PDA, cellphone, or laptop.

The programs may be written in C or Python, or Java, Brew or any other programming language. The programs may be resident on a storage medium, e.g., magnetic or optical, e.g. the computer hard drive, a removable disk or media such as a memory stick or SD media, wired or wireless network based or Bluetooth based Network Attached Storage (NAS), or other removable medium or other removable medium. The programs may also be run over a network, for example, with a server or other machine sending signals to the local machine, which allows the local machine to carry out the operations described herein.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

What is claimed is:

1. A device comprising:
a computer part that determines information indicative of current location, and information indicative of how much carbon emissions will be produced by traveling from a current location to another location, and maintains a count of total carbon emissions.

2. A device as in claim 1, wherein said computer part also stores a calendar of events, and uses an event from said calendar of events as said another location.

3. A device as in claim 1, wherein said computer part stores information about multiple ways to travel between locations, and provides information about multiple ways of getting from said current location to said another location, and provides information about carbon emissions for said ways.

4. A device as in claim 1, further comprising an automatic position detecting part, and wherein said computer part uses said information from said automatic position detecting part to find said current location.

5. A device as in claim 1, wherein said computer part stores information about a specific automobile that will be used to travel from said current location to said another location, and said total carbon emissions is based on information about said specific automobile.

6. A device as in claim 1 wherein said computer part also accumulates a score indicative of how much carbon emissions have been produced by a user's previous travels between said locations.

7. A device comprising:
a computer part that determines information indicative of locations, and accumulates a score indicative of how much carbon emissions have been produced by a user's travels between said locations.

8. A device as in claim 7, wherein said computer part is a portable computer that is carried with the user, and has an automatic position sensing part that senses its current position.

9. A device as in claim 7, wherein said computer part also stores a calendar of events, and determines modes of future travel to said events, and information about said future travel to said events.

10. A device as in claim 9, wherein said computer part stores information about multiple ways to travel between locations, and provides information about multiple ways of getting between said locations, and provides information about carbon emissions for each of a plurality of said multiple ways.

11. A device as in claim 8, wherein said computer part is part of a portable phone.

12. A device as in claim 7, wherein said computer part stores information about a specific automobile that will be used to travel from said current location to said another location, and said total carbon emissions is based on information about said specific automobile.

13. A method, comprising:
storing calendaring events in a computer, where said calendaring events include times for the events and locations that a user needs to be for said events at said times;
determining a number of different alternatives for getting to one of said locations stored as part of said event, and times for each of said alternatives for getting to said one location, and determining times associated with said different alternatives for getting to said one location;
determining a longest time among said postulated times; and
at a time prior to said longest time, providing information about said different alternatives.

14. A method as in claim 13, further comprising determining a user's postulated position at said times for the events.

15. A method as in claim 13, wherein said postulated times include times for advance purchases of plane tickets.

16. A method as in claim 13, wherein said alternatives include different modes of transportation.

17. A method as in claim 13, wherein said computer provides estimates of total carbon emissions for said different alternatives.

18. A method as in claim 13, wherein said computer stores a database of costs for said alternatives, and returns costs with said alternatives.

19. A method as in claim 13, wherein said costs include a parking cost.

20. A method as in claim 13, wherein said computer stores a database of times to traverse roadways at certain times of day.
